(19) United States
(12) Patent Application Publication
(10) Pub. No.: US 2026/0238009 A1
(43) Pub. Date: Aug. 13, 2026

(54) HOME GRID FOR IMPROVED EFFICIENCY OF SOLAR ENERGY

(71) Applicant: Eric M Crane, Long Beach, CA (US)

(72) Inventor: Eric M Crane, Long Beach, CA (US)

(21) Appl. No.: 19/048,819

(22) Filed: Feb. 7, 2025

(51) Int. Cl. H02J 3/28; F03G 6/00; F24D 17/00; F24D 17/02; F28D 20/00

(52) U.S. Cl. CPC H02J 3/28; F03G 6/004; F03G 6/071; F03G 6/092; F03G 6/111; F24D 17/0042; F24D 17/02; F28D 20/0034; F28D 2020/0013; F28D 2020/0069; H02J 2101/10; H02J 2101/24; H02J 2105/42

(57) ABSTRACT

A home grid storage device and method storage of electricity generated on-site, optionally using photovoltaic panels. A heat reservoir is coupled to an inverter-based heat pump to concentrate/remove heat from the heat reservoir. A cold reservoir has a cryogenic heat pump coupled to the cold reservoir. An optional intermediate reservoir is coupled to the cold reservoir. Heat removed from the cold reservoir is exchanged with the intermediate reservoir, and heat in the intermediate reservoir is exchanged with the heat reservoir. One or more of a refrigerant supply line and a return line are coupled to a compressor and condenser assembly. An organic Rankine cycle (O.R.C.) engine and valves are connected to O.R.C. supply-return assemblies, a heat reservoir, and an evaporator condenser coil. An assembly in the central air conditioning system's return air plenum containing subassemblies to provide air filtration, dehumidification, preheating, and precooling to the building.

### BACKGROUND

### Technical Field

The present disclosure generally relates to energy generation and storage. More specifically, the system relates to systems and methods for a more efficient use of energy generated without the use of fossil fuels.

### Description of the Related Art

In both commercial buildings and residences, solar power is generated typically using solar panels and is stored on site via electrochemical batteries including but not limited to lithium-ion and lead acid. Lead acid does not provide significant capacity relative to the production of a solar installation, and while lithium ion provides more, the cost of lithium-ion is prohibitively expensive and does not provide sufficient storage to justify the expense. Other types of power generation that are more common in utility, such as in industrial and commercial settings include molten salt, compressed air, flywheels, flow batteries (two tanks of a liquid cation and anion), stacked weights, and water pumped uphill to a storage pond to create hydropower when it flows back downhill. These types of power generators are generally larger than the space available for storage at an average residence, and some need to be at a significant scale to be economically practical.

### SUMMARY

In an embodiment, a home grid storage and utilization device for electricity generated on-site, the storage and utilization device includes an electric generator coupled to the home grid storage and utilization device to provide power generated on-site for operation. A first reservoir is configured to provide a source of cold. A cryogenic heat pump is coupled to the first reservoir. A second reservoir is configured to provide a source of heat. An inverter-based heat pump is coupled to the second reservoir for concentrating/removing heat from the second reservoir. A third reservoir is coupled to the first reservoir, wherein heat removed from the first reservoir is exchanged with the third reservoir, and heat in the third reservoir is exchanged with the second reservoir.

In an embodiment, which may be combined with the preceding embodiment, the electric generator is configured by passive power generation.

In an embodiment, which may be combined with one or more of the preceding embodiments, the electric generator include photovoltaic panels to generate passive power for the operation of the home grid storage and utilization device.

In an embodiment, which may be combined with one or more of the preceding embodiments, the electric generator is configured for active power generation.

In an embodiment, which may be combined with one or more of the preceding embodiments, the electric generator is a natural gas or propane-powered electric generator.

In an embodiment, which may be combined with one or more of the preceding embodiments, the home grid storage and utilization device includes valves, a circulation pump, and tubing configured to enter and exit the first reservoir via the refrigerant supply line and return line.

In an embodiment, which may be combined with one or more of the preceding embodiments, the refrigerant supply line and the return line are configured to couple to an on-site air conditioning system.

In an embodiment, which may be combined with one or more of the preceding embodiments, further comprising one or more of a refrigerant supply line and a return line coupled at a first end to the first reservoir to supply heated refrigerant to the first reservoir.

In an embodiment, which may be combined with one or more of the preceding embodiments, the home grid storage and utilization device is configured to remove heat from refrigerant of the air conditioning system using cold from the cryogenic heat pump powered by the electric generator.

In an embodiment, which may be combined with one or more of the preceding embodiments, a compressor and condenser assembly of a residential air conditioning system are included at the residence. The supply line and return line are intercepted by valves, a circulation pump, and tubing that enter and exit the first reservoir.

In an embodiment, which may be combined with one or more of the preceding embodiments, the home grid storage and utilization device further includes an organic Rankine cycle (O.R.C.) engine and valves, wherein an O.R.C. supply-return assembly is coupled to the first reservoir and the second reservoir to provide a path for a working fluid to travel between the first reservoir and the O.R.C. and the second reservoir and the O.R.C. to provide the temperature difference for the O.R.C. to generate electricity.

In an embodiment, which may be combined with one or more of the preceding embodiments, the home grid storage and utilization device further includes an evaporator-condenser coil coupled to the O.R.C., and wherein additional refrigerant supply lines are connected to the third reservoir.

In an embodiment, which may be combined with one or more of the preceding embodiments, the working fluid is ethanol, ethylene glycol or propylene glycol.

In an embodiment, which may be combined with one or more of the preceding embodiments, further includes an assembly having a particulate air filter, dehumidification subassembly, and preheating subassembly arranged in a return air plenum of the air conditioning system.

In an embodiment, which may be combined with one or more of the preceding embodiments, the home grid storage and utilization device further includes a pre-cooling subassembly installed in the return air plenum of a central air conditioning system.

In an embodiment, which may be combined with one or more of the preceding embodiments, the home grid storage and utilization device further includes two supply and return lines that connect to the first and second reservoirs to service the relevant subassemblies in the return air plenum assembly.

In an embodiment, which may be combined with one or more of the preceding embodiments, the home grid storage and utilization device further includes a supply and return line connected to the second reservoir to serve the preheating subassembly and to regenerate the dehumidification subassembly.

In an embodiment, which may be combined with one or more of the preceding embodiments, the home grid storage and utilization device further includes a drain line connecting the dehumidification subassembly to an existing drain line of a condensate pump or burner of the central air conditioning system.

In an embodiment, a method of home grid storage and utilization of energy, the method includes coupling the home grid storage and utilization device to an electric generator to provide power generated on-site for operation; providing a first reservoir configured to supply a source of cold; providing a cryogenic heat pump coupled to the first reservoir; providing a second reservoir configured to provide a source of heat; providing an inverter-based heat pump coupled to the second reservoir for concentrating/removing heat from the second reservoir; and providing a third reservoir coupled to the first reservoir, wherein heat removed from the first reservoir is exchanged with the third reservoir, and heat in the third reservoir is exchanged with the second reservoir.

In an embodiment, which may be combined with the preceding embodiment, the method further includes providing an organic Rankine cycle (O.R.C.) engine and valves, and an O.R.C. supply-return assembly coupled to the first reservoir and the second reservoir to provide a path for a working fluid to travel between the first reservoir and the O.R.C. and the second reservoir and the O.R.C. to provide the temperature difference for the O.R.C. to generate electricity.

### BRIEF DESCRIPTION OF THE DRAWINGS

The drawings presented herein show illustrative embodiments of the disclosure. They do not illustrate all embodiments. Other embodiments may be used in addition to or instead of the illustrative embodiments. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps. The drawings are not intended to depict every feature of every implementation nor relative dimensions of the depicted elements, and are not drawn to scale.

FIG. 1A illustrates an overview of a home grid storage device consistent with an illustrative embodiment.

FIG. 1B illustrates an overview of a home grid storage device with a connection between the first reservoir and the refrigerant supply and return of the residence's existing air conditioning system.

FIG. 2 is an overview showing the operational environment for a home grid energy storage device, consistent with an illustrative embodiment.

FIG. 3 is a first flowchart illustrating the operation of the home grid storage device such as shown in FIGS. 1A and 1B.

FIG. 4 is a second flowchart illustrating the operation of the home grid storage device such as shown in FIGS. 1A and 1B during warm weather operation, consistent with an illustrative embodiment.

FIG. 5 is a third flowchart illustrating operation of the home grid storage device such as shown in FIGS. 1A and 1B during cold weather operation, consistent with an illustrative embodiment.

FIG. 6 is a fourth flowchart illustrating software control and operation of an Organic Rankine Cycle Engine (ORC), consistent with an illustrative embodiment.

### DETAILED DESCRIPTION

In the following description, numerous specific details are set forth to clearly describe various specific embodiments disclosed herein. However, one skilled in the art will understand that the subject matter of the present disclosure may be practiced without all of the specific details discussed below. In other instances, well-known features may not have been described so as not to obscure the invention with unnecessary detail regarding known features.

As used herein, the term “and/or” is to be interpreted broadly is to be understood to refer to all or some of the elements. For example, “at least one of (a) and/or (b) means the teaching pertains only to element (a), or only to element (b), or to both element (a) and element (b). In another example, ”at least one of (a), (b), and/or (c), means the teaching pertains to only element (a), or only to element (b), or only element (c), or to elements (a) and (b), elements (a) and (c), elements (b) and (c), or to all of (a), (b) and (c).

Also, it is to be understood that the phraseology and terminology used herein is for the purpose of description and should not be regarded as limiting. The use of “including,” comprising, “ or ”having“ and variations thereof herein is meant to encompass the items listed thereafter and equivalents thereof as well as additional items. Unless limited otherwise, the terms ”connected,“ coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

As used herein, the term “warm weather” refers to an ambient temperature of about or within five degrees of 65 degrees Fahrenheit (F) or higher.

As used herein, the term “cold weather” refers to an ambient temperature of about or within five degrees of 64 degrees F or lower.

As used herein, the term “hot water” refers to water that is at least 98 degrees F.

As used herein, the term “cold water” refers to water that is 97 degrees F or lower.

As discussed herein, an assembly that will be installed in the return air plenum in central air conditioning systems. This assembly has an air filter, dehumidifier, and pre-heating functions. For another embodiment, this assembly may also include evaporation coils that are supplied by a loop of a working fluid, including but not limited to ethanol, ethylene glycol or propylene glycol. Other types of working fluid that may be used include water, saline, methanol, other alcohols (methanol and ethanol are also referred to as methyl alcohol and ethyl alcohol), hydraulic fluid, oil of various viscosities, a water and glycerin solution, carbon dioxide gas, nitrogen gas, air, helium, and any refrigerant such as R-134A, R-410A. It is to be understood that the list of aforementioned list of possible working fluids has been provided for illustrative purposes and is not exhaustive.

### Overview

The teachings of the present disclosure provide for a device and method to consume substantially all of the electricity produced by an on-site generator, such as solar photovoltaic panels, and in so doing, reduce the import of electricity from the electric grid and reduce the use of natural gas, propane, and/or fuel oil for hot water and home heating. There is a reduction in carbon dioxide emissions, and methane emissions as compared to conventional heating and cooling devices.

According to one or more embodiments of the present disclosure, a heat concentrating/removing technology is used to service reservoirs of hot and cold temperatures, e.g., “thermal batteries,” to utilize most (if not all) of the output of an onsite solar panel installation. Most solar installations typically energize the main electrical service panel, and whatever energy is not used by any appliances that happen to be operating in a building is sent back to the utility grid. A solar power generating system is sized to generate only as much power over the course of a year as the residents have used in recent years. However, according to the present disclosure, a solar power generating system can be sized according to how much power is required to cool a cold reservoir in between the intervals of when the air conditioner is operational to cool the residence. Similarly, the power generating system can be sized according to the power needed for gathering heat for the reservoir system during cold weather. Combining this sizing information with utilizing the waste heat from the air conditioner for hot water by including an induction element to provide infinite hot water may be performed.

The device may reduce or temporarily cease operation to allow for other electrical loads in the house to run off of the solar-generated electricity, which is also realized with the home grid storage device of the present disclosure. As the system is designed to use all of the power generated by the system and meet the needs of a portion of the residence's non-thermal-end-use electrical loads, the system may be a type of a microgrid-enabling device. If the system is installed in combination with a microgrid interconnect device and a grid-forming inverter, a microgrid can be created. The system also provides for extending the benefit of onsite solar panels after the sun sets because the need for the cold and heat will be present into the night, and as long as they are of sufficient capacity, they will not be depleted upon the first use after the solar panels stop producing. In addition, the organic Rankine cycle (O.R.C.) engine allows for generating electricity at night as well, something that can boost the overall efficiency of the system and provide additional value to the user. The system may reduce or eliminate the instantaneous fluctuations and intermittency in the output of the solar panels by adjusting the consumption of the power produced by the solar panels to allow for a constant amount of energy to be available for use in the house or sent back to the utility grid, according to user preference. In utility territories where they are offered, the device according to the present disclosure will enable users to participate in demand response programs to either delay the use of certain appliances or cease its own operation to send as much power as the solar panels are producing to the grid to reduce the strain due to excessive demand. In addition, the system may extend the life of an existing air conditioner and a heater by reducing the frequency and intensity of their operation.

A home grid storage device for electricity generated on-site includes three reservoirs: a first reservoir configured to provide a source of cold, a second reservoir configured to provide a source of heat, and a third reservoir whose primary purpose is to facilitate the transfer and concentration of heat removed from the first reservoir into the second reservoir. The first reservoir is coupled to the third reservoir via an inverter-based, cryogenic heat pump for the purpose of generating cold temperatures by removing heat from the first reservoir and transferring the heat into the third reservoir. The third reservoir is coupled to the second reservoir via an inverter-based heat pump, which is configured to extract and concentrate heat from the third reservoir concentrating the heat as it moves into the second reservoir. One or more of a refrigerant supply line and a return line are coupled to a compressor and condenser assembly of the existing air conditioning system of the residence. In one embodiment, the supply line and return line may be intercepted by valves, a circulation pump, and tubing that enter and exit the cold reservoir. One purpose of this construction is to remove the heat from the air conditioning system's refrigerant using the cold that has been built up by the cryogenic heat pump that was powered by the on-site generator, in this case, solar photovoltaic panels.

An organic Rankine cycle (O.R.C.) engine and valves, and O.R.C. supply-return assemblies utilizing a working fluid such as ethylene glycol or propylene glycol may be coupled to the first reservoir and the second reservoir. An evaporator-condenser coil is coupled to the O.R.C., and refrigerant lines connected to the third reservoir.

An assembly includes a particulate air filter, dehumidification subassembly, preheating subassembly, and in one embodiment, a pre-cooling subassembly are all installed in the return air plenum of the existing residence's central air conditioning system. There is a supply and return line connected to the second reservoir to serve the preheating subassembly and to regenerate the dehumidification subassembly. In some embodiments of the present disclosure, there is a supply and return line to the first reservoir to serve the pre-cooling subassembly. A drain line will connect the dehumidification subassembly to the existing drain line of the existing condensate pump or burner in the existing central air conditioning system. A subassembly connected to the second reservoir provides domestic hot water to the residence. The subassembly uses heat from the second reservoir to heat the incoming domestic water supply via a heat exchanger. The subassembly may provide continuous hot water, and the subassembly may have an electromagnetic induction-based heating element as a backup source of heat if the heat reservoir is depleted.

### Example Embodiment(s)

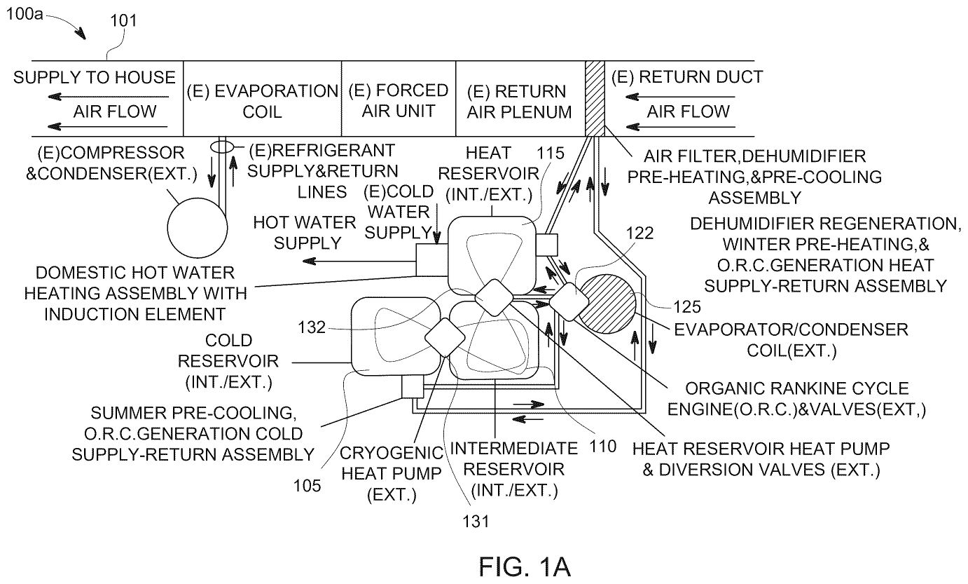

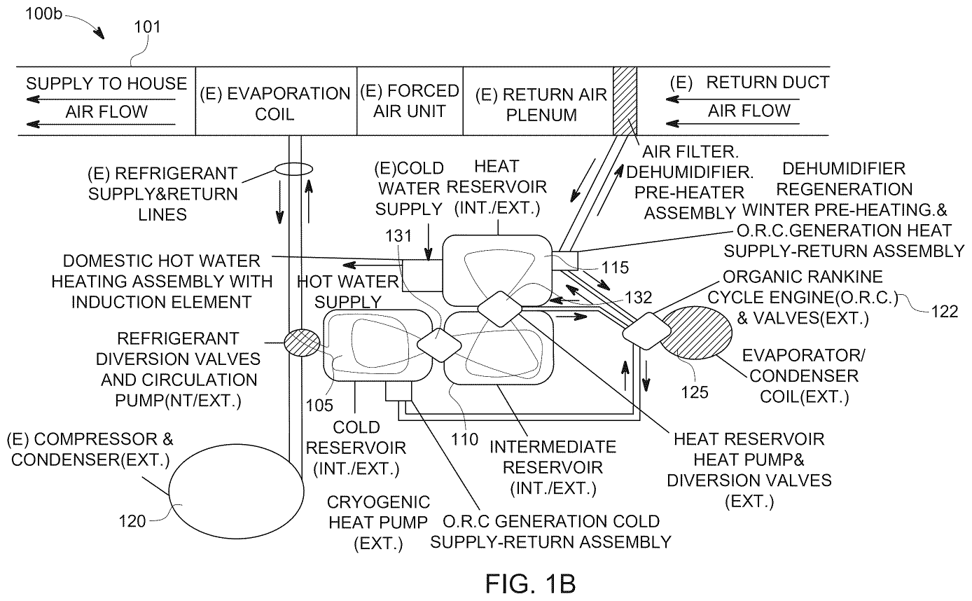

FIGS. 1A and 1B illustrate an overview of a home grid storage device 100A, 100B consistent with an illustrative embodiment. FIG. 1B shows the home grid storage device of FIG. 1A with a connection between the first reservoir and the refrigerant supply and return of the residence's existing air conditioning system. There are three reservoirs shown in which a working fluid (e.g., including but not limited to ethanol, propylene glycol) may circulate to exchange heat/cold. For example, a cold reservoir 105, an intermediate reservoir 110, and a heat reservoir 115. While the intermediate reservoir 110 is optional, there is an increase in efficiency of operation by including the third (intermediate) reservoir. The cold reservoir 105, intermediate reservoir 110, and heat reservoir 115 are in thermal communication. A connection to the house 101 provides airflow, and includes a return duct, return air plenum, forced air unit, and an evaporation coil. A compressor and condenser 120 (FIG. 1B), Organic Rankine Cycle Engine (O.R.C.) and valves 122, and an evaporator and condenser 125, are shown, with the O.R.C. in communication with all three reservoirs (cold reservoir 105, intermediate reservoir 110, and heat reservoir 125). Heat pumps 130, 131 are shown between the reservoirs to perform/assist in heat exchange. A discussion of all the aforementioned components is provided herein.

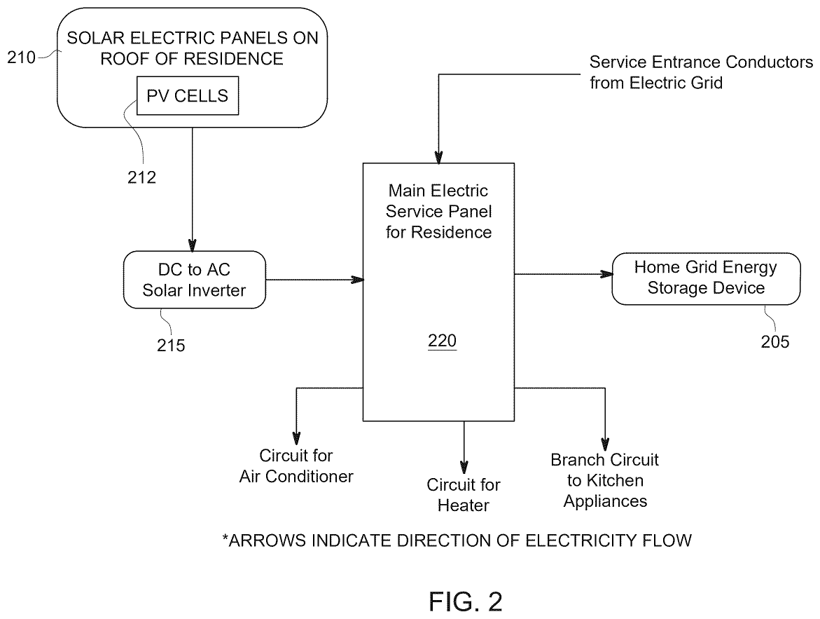

FIG. 2 is an overview showing the operational environment for a home grid energy storage device, consistent with an illustrative embodiment. The home grid energy storage device 205 is shown, which in this embodiment is coupled to a main electric service panel for residence 220. There are shown solar electric panels 210, typically arranged on the roof of a residence, and photovoltaic cells 212 on the panels that convert the sunlight into DC electricity. A solar inverter 215 inverts the DC electricity to AC electricity that is provided to the main electric service panel for residence 220. There may be service entrance conductors from the electric grid to supply power when there is insufficient on-site power generation.

### Example of Operations of Illustrative Embodiments

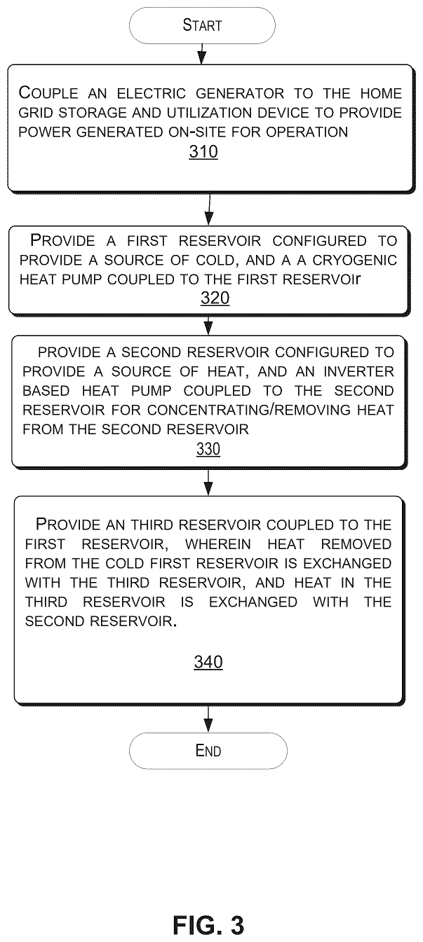

FIG. 3 is a flowchart providing illustrative operations of the home grid storage device as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement data. In each process, the order in which the operations are described is not intended to be construed as a limitation, and any number of the described blocks can be combined in any order and/or performed in parallel to implement the process. It is to be understood, that the operations explained herein below in FIGS. 3 through 6 (in conjunction with FIGS. 1 and 2) are provided for illustrative and explanatory purposes, and the appended claims are not limited to the descriptions and illustrations discussed below and shown herein.

Referring now to FIG. 3, a method of providing a home grid storage and utilization device of energy generated on-site, includes coupling the home grid storage and utilization device to an electric generator to provide power generated on-site for operation (operation 205).

A first reservoir is configured to supply a source of cold (operation 310). A cryogenic heat pump coupled to the first reservoir (operation 320). A second reservoir is coupled to an inverter-based heat pump to concentrate/remove heat from the second reservoir (operation 330). A third reservoir is coupled to the first reservoir (operation 340), wherein heat removed from the first reservoir is exchanged with the third reservoir, and heat in the third reservoir is exchanged with the second reservoir. The aforementioned provides a general overview of the basic operation of the home grid storage device. It is to be understood that the device may be constructed with only two reservoirs (a first cold reservoir and a second heat reservoir), but the device operates more efficiently with at least an additional intermediate reservoir.

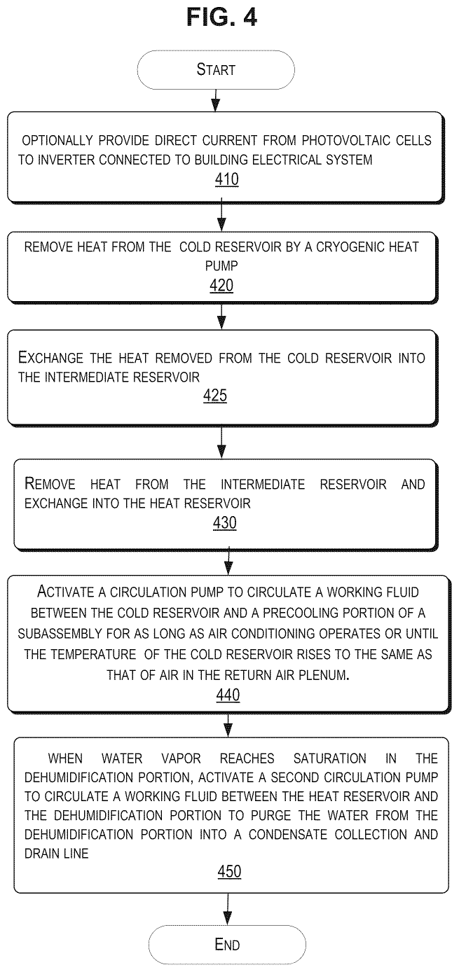

FIG. 4 is a flowchart illustrating operation of the home grid storage device during warm weather operation, which is about 65 degrees F or above, consistent with an illustrative embodiment. In all operations, the home grid storage device may be provided direct current from alternative energy sources, such as photovoltaic cells, but the appended claims are not so limited. In this embodiment, direct current may be optionally provided from photovoltaic cells (operation 410). In such construction, an inverter is used to provide alternating current. The inverter may be connected to the electrical system of a building, and the power is available for use by appliances in use in the building.

Heat is removed from the cold reservoir by a cryogenic heat pump (operation 420). The heat removed from the cold reservoir will be exchanged into the intermediate reservoir as part of the operation of the cryogenic heat pump (operation 425).

After the cryogenic heat pump begins to operate, a second inverter-based pump in the device will activate and remove heat from the intermediate reservoir and exchange the heat into the heat reservoir (operation 430). Thus the cold reservoir, intermediate reservoir, and heat reservoir are coupled to provide for the thermal transfer of energy from one reservoir to another, a construction heretofore unknown.

At operation 440, when an existing air conditioning system activates, a sensor in the units subassembly in the return air plenum will in turn activate a circulation pump to circulate a working fluid between the cold reservoir and a precooling portion of a subassembly for as long as air conditioning (A/C) operates or until the temperature of the cold reservoir rises to the same as that of air in the return air plenum.

When water vapor reaches saturation in a dehumidification portion, a second circulation pump is activated to circulate a working fluid between the heat reservoir and the dehumidification portion to purge the water from the dehumidification portion into a condensate collection and drain line (operation 450).

If the heat reservoir is saturated with heat and is unable to accept more, the second heat pump will continue to remove heat from the intermediate reservoir, but valves will direct the compressed refrigerant to the Organic Rankine Cycle Engine (ORC) and Evaporator/Condenser coil to exhaust the heat outside.

As measured by current transformers installed in the main electric service panel; or load sensing, if no appliances are using power, the device consumes as much power as the inverter sends to the electrical system. This feature is provided by running the inverter-based heat pump (e.g. cryogenic heat pump) to remove heat from the cold reservoir, reducing the temperature such that ice may be made out of water serving as a phase change material. Thus, in an embodiment, the device will consume all of the power generated by an on-site source of generation (such as photovoltaic cells) instead of back-feeding electricity to the electric grid. There is a benefit to consuming the power rather than back feeding to the utility grid because, in some states, the credit given by a utility, (e.g. California) is much less than what a homeowner pays for power. Using the power on-site retains the full value of the power that the homeowner generates.

If there is a hot water demand, incoming cold water will run through the subassembly connected to the heat reservoir to be heated. As the temperature of the heat reservoir decreases, and there is no waste heat available from the building A/C, an induction-based heating element will activate to provide supplemental heat.

As an additional energy-saving measure, the user will be able to set the unit to continue to operate After sunset, the waste heat from an existing A/C system can be captured and transferred to the heat reservoir to maintain its operating temperature to meet potent domestic hot water needs overnight and in the morning before the solar panels start producing electricity.

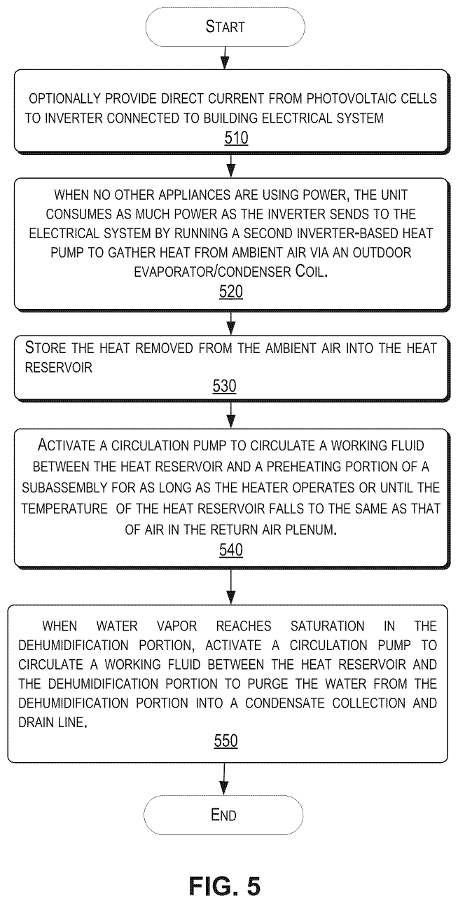

FIG. 5 is a flowchart illustrating operation of the home grid storage device during cold weather operation, which is about 64 degrees F or below, consistent with an illustrative embodiment.

Similar to the flowchart in FIG. 4, there may be on-site generation of power provided, such as from photovoltaic cells to an inverter connected to a building's electrical system (operation 510).

When no appliances are consuming power, the device consumes as much power as the inverter sends to the electrical system by running a second inverter-based heat pump to gather heat from ambient air via an outdoor evaporator/condenser coil (operation 520).

The heat removed from the ambient air is stored in the heat reservoir (operation 530).

A circulation pump is activated to circulate a working fluid, such as ethanol, propylene glycol, etc., between the heat reservoir and a preheating portion of a subassembly for as long as the heater operates or until the temperature of the heat reservoir falls to the same as that of air in the return air plenum (operation 540).

When water vapor reaches saturation in the dehumidification portion, a circulation pump is activated to circulate a working fluid between the heat reservoir and the dehumidification portion to purge the water from the dehumidification portion into a condensate collection and drain line (operation 550).

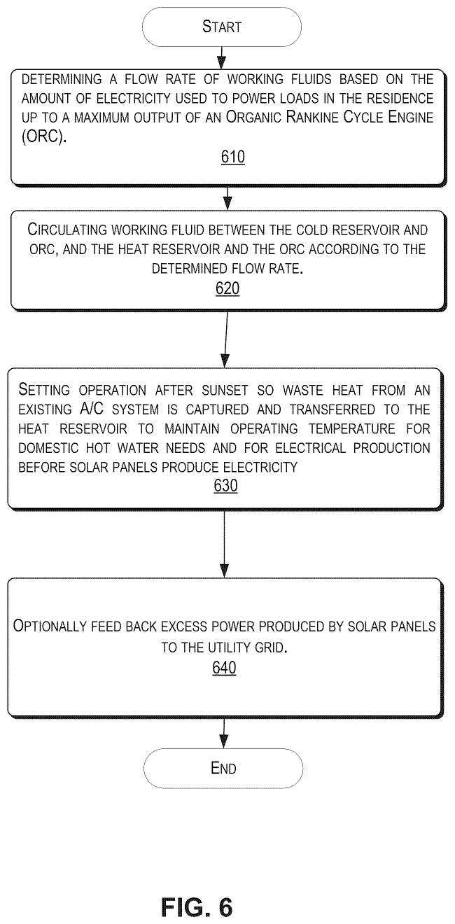

FIG. 6 is a flowchart illustrating software control and operation of an Organic Rankine Cycle Engine (ORC), consistent with an illustrative embodiment.

Based on the amount of electricity used to power loads in the residence, the flow rate of the working fluids is determined up to the maximum output of an organic Rankine cycle engine (ORC) (operation 610). Besides exhausting excess heat from the intermediate reservoir and/or to generate electricity in the summer, the ORC is used to generate electricity at any time of the day or night, and in any season, according to user preference.

For example, through circulating working fluid between the cold reservoir and the ORC, and the heat reservoir and the ORC, the flow rate of the working fluids is determined by the amount of electricity used to power loads in a residence, up to the point of reaching the maximum output of the ORC. The ability to control the flow rate of working fluids to match electrical production with the demand of a residence is unknown heretofore.

The working fluid is circulated between the cold reservoir and ORC; and the heat reservoir and ORC according to the determined flow rate (operation 620).

Optionally, the device can be configured so that after sunset the waste heat from an existing A/C system is captured and transferred to the heat reservoir to maintain an operating temperature for domestic hot water needs and for electrical production before solar panels produce electricity in the morning (operation 630).

The excess power produced by the solar panels may be optionally fed back to the grid (operation 640). However, as previously discussed herein, the excess power may also be consumed by the device.

With regard to system control, the operation of the device will be governed by software and other electronic and electrical controls. For example, there may be a setting through which a user may customize the operation according to their preference. Multiple options may be customizable, of which one is the ability to opt-out or opt-in to “grid service programs” that include selling power into electricity markets, participating in utility demand response programs, virtual power plant aggregation, and other markets and services that presently exist or may be developed. If the user participates in such grid service programs, the device will cease to consume any excess power produced by the solar panels and allow for the excess power to be back-fed to the utility grid at the time the power is desired to ensure successful participation in a given program.

Likewise, the user will have the option to add the production of the ORC to any grid service programs to which they opt to participate. As part of participating in grid service programs, the device will track the net amount of power backed to the utility grid to perform measurement, reporting, and verification duties.

### Conclusion

It is to be understood that with regard to computer-implemented methods and systems described herein, computer program instructions may be provided to a processor of a general-purpose computer to render it into a special-purpose computer configured to per the authentication disclosed herein. In addition, a special purpose computer, or other programmable data processing apparatus may be used to produce a machine in which the instructions are executed via the processor of the computer or other programmable data processing apparatus to provide for implementing the functions/acts specified in the flowchart and/or block diagram block or blocks.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,’ ‘an,” and “the” include plural references unless the content clearly dictates otherwise. The term plurality“ includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one’, unless explicitly so stated. Moreover, no element, component, method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for”, and no method or process step herein is to be construed under those provisions unless the step, or steps, are expressly recited using the phrase “step(s) for . . . ”.

What is claimed is:

1. A home grid storage and utilization device for electricity generated on-site, the storage and utilization device comprising:
an electric generator coupled to the home grid storage and utilization device to provide power generated on-site for operation;
a first reservoir configured to provide a source of cold;
a cryogenic heat pump coupled to the first reservoir;
a second reservoir configured to provide a source of heat; and
an inverter-based heat pump coupled to the second reservoir for concentrating/removing heat from the second reservoir.

2. The home grid storage and utilization device according to claim 1, further comprising:
a third reservoir coupled to the first reservoir, wherein heat removed from the first reservoir is exchanged with the third reservoir, and heat in the third reservoir is exchanged with the second reservoir.

3. The home grid storage and utilization device according to claim 1, wherein the electric generator is configured to generate passive power for operation.

4. The home grid storage and utilization device according to claim 1, wherein the electric generator comprises photovoltaic panels to generate passive power for operation.

5. The home grid storage and utilization device according to claim 1, wherein the electric generator is configured to generate active power for operation.

6. The home grid storage and utilization device according to claim 4, wherein the electric generator comprises a natural gas, gasoline, diesel, or propane-powered electric generator.

7. The home grid storage and utilization device according to claim 1, further comprising one or more of a refrigerant supply line and a return line coupled at a first end to the first reservoir to supply heated refrigerant to the first reservoir.

8. The home grid storage and utilization device according to claim 7, further comprising valves, a circulation pump, and tubing configured to enter and exit the first reservoir via the refrigerant supply line and return line.

9. The home grid storage and utilization device according to claim 8, wherein the refrigerant supply line and the return line are configured to couple to an on-site air conditioning system.

10. The home grid storage and utilization device according to claim 9, configured to remove heat from the refrigerant of the air conditioning system using the ice from the cryogenic heat pump powered by the electric generator.

11. The home grid storage and utilization device according to claim 10, further comprising:
a compressor and condenser assembly of the air conditioning system of the residence, wherein the supply line and return line are intercepted by valves, a circulation pump, and tubing that enter and exit the first reservoir.

12. The home grid storage and utilization device according to claim 1, further comprising an organic Rankine cycle (O.R.C.) engine and valves, wherein an O.R.C. supply-return assembly is coupled to the first reservoir and the O.R.C. and the second reservoir and the O.R.C. to provide a temperature difference for the O.R.C. to generate electricity.

13. The home grid storage and utilization device according to claim 12, wherein the working fluid comprises ethylene glycol or propylene glycol.

14. The home grid storage and utilization device according to claim 12, further comprising an evaporator-condenser coil coupled to the O.R.C. ; and wherein additional refrigerant supply lines are connected to the third reservoir.

15. The home grid storage and utilization device according to claim 12, further comprising an assembly including a particulate air filter, dehumidification subassembly, preheating subassembly arranged in a return air plenum of the air conditioning system.

16. The home grid storage and utilization device according to claim 15, further comprising a pre-cooling subassembly are installed in the return air plenum of a central air conditioning system.

17. The home grid storage and utilization device according to claim 15, further comprising two supply and return lines that connect to the first and second reservoirs to service the relevant subassemblies in the return air plenum assembly.

18. The home grid storage and utilization device according to claim 12, including a supply and return line connected to the second reservoir to serve the preheating subassembly and to regenerate the dehumidification subassembly.

19. The home grid storage and utilization device according to claim 18, further comprising a drain line connecting the dehumidification subassembly to an existing drain line of a condensate pump or burner of the central air conditioning system.

20. A home grid storage and utilization device for electricity generated on-site, the storage and utilization device comprising:
an electric generator coupled to the home grid storage and utilization device to provide power generated on-site for operation;
a first reservoir configured to provide a source of cold;
a cryogenic heat pump coupled to the first reservoir;
a second reservoir configured to provide a source of heat; a first inverter-based heat pump coupled to the second reservoir for concentrating/removing heat from the second reservoir;
a third reservoir coupled to the first reservoir, wherein heat removed from the first reservoir is exchanged with the third reservoir, and heat in the third reservoir is exchanged with the second reservoir; and
a second operating configuration for the first inverter-based heat pump, to gather heat from ambient air via an outdoor evaporator/condenser coil to concentrate and store heat in the second reservoir.

21. The device according to claim 20, wherein the electric generator comprises photovoltaic panels to generate passive power for operation, and the electric generator includes an inverter to generate alternating current; and
wherein in cold weather operation below about 64 degrees F, the device is configured to consume all of the power generated on-site source by the electric generator via operation of the first inverter-based heat pump to concentrate and store heat in the second reservoir.

22. The device according to claim 20, wherein the electric generator comprises photovoltaic panels to generate passive power for operation, and the electric generator includes an inverter to generate alternating current from the direct current output by the photovoltaic cells; and
wherein the device is configured to reduce operation of one or more heat pumps and provide at least some alternating current generated by the electric generator for appliance consumption.

23. The device according to claim 20, wherein the electric generator comprises photovoltaic panels to generate passive power for operation, and the electric generator includes an inverter to generate alternating current from the direct current output by the photovoltaic cells, and
wherein the inverter is connected to the electrical system of a building to provide power for appliance consumption, and
wherein the device is configured to sense appliance consumption of current in the building and reduce operation of one or more heat pumps to provide at least some alternating current generated by the electric generator for appliance use.

24. The device according to claim 23, further configured to cease operation of one or more heat pumps when an amount of power drawn by the appliance consumption exceeds an amount of on-site generated power by the electric generator.

25. The device according to claim 24, further configured to commence operation of one circulation pump when preheating is needed to service a load by circulating heat from the second reservoir.

26. The device according to claim 24, further configured to determine a hot water demand, and run cold water to run through a subassembly connected to the second reservoir to be heated, and the device further comprising:
an induction-based heating element in the subassembly configured to activate to supplement the heat being supplied from the second reservoir.

27. A method of home grid storage and utilization of energy, the method comprising:
coupling the home grid storage and utilization device to an electric generator to provide power generated on-site for operation;
providing a first reservoir configured to supply a source of cold;
providing a cryogenic heat pump coupled to the first reservoir;
providing a second reservoir configured to provide a source of heat;
providing an inverter-based heat pump coupled to the second reservoir for concentrating/removing heat from the second reservoir; and
providing a third reservoir coupled to the first reservoir, wherein heat removed from the first reservoir is exchanged with the third reservoir, and heat in the third reservoir is exchanged with the second reservoir.

28. The method according to claim 27, further comprising providing an organic Rankine cycle (O.R.C.) engine and valves, and an O.R.C. supply-return assembly coupled to the first reservoir and the second reservoir to provide a path for a working fluid to travel between the first reservoir and the O.R.C. and the second reservoir and the O.R.C. to provide a temperature difference for the O.R.C. to generate electricity.
